(19) United States
(12) Patent Application Publication
(10) Pub. No.: US 2026/0352653 A1
(43) Pub. Date: Nov. 5, 2026

(54) TOKEN CONTROL DEVICE THAT EXECUTES CONTROL RELATED TO TOKEN, COMPUTER-READABLE, NON-TRANSITORY RECORDING MEDIUM HAVING TOKEN CONTROL PROGRAM RECORDED THEREON, AND SYSTEM

(71) Applicant: KYOCERA Document Solutions Inc., Osaka (JP)

(72) Inventor: Koki NAKAJIMA, Osaka (JP)

(73) Assignee: KYOCERA Document Solutions Inc., Osaka (JP)

(21) Appl. No.: 19/660,833

(22) Filed: Apr. 28, 2026

(30) Foreign Application Priority Data
Apr. 30, 2025 (JP) 2025-075202
Apr. 30, 2025 (JP) 2025-075203
Apr. 30, 2025 (JP) 2025-075204

(51) Int. Cl. H04L 9/40

(52) U.S. Cl. CPC H04L 63/083

(57) ABSTRACT

When a client requests permission for a user to log in to an application provision device that provides applications, each having an application ID different in each of environments, and the permission to log in is granted, a token control device notifies a token to the client, and associates the application ID of the application and a URL for making access to the application with the token, with respect to each of the application IDs, and when an application utilization instruction, instructing to utilize the application, and including the token and the application ID, is transmitted from the client, the token control device notifies the token included in the application utilization instruction and the URL associated with the application ID, to the client.

### INCORPORATION BY REFERENCE

This application claims priority to Japanese Patent Application No.2025-075202 filed on Apr. 30, 2025, Japanese Patent Application No. 2025-075203 filed on Apr. 30, 2025, and Japanese Patent Application No. 2025-075204 filed on Apr. 30, 2025, the entire contents of which are incorporated by reference herein.

### BACKGROUND

The present disclosure relates to a token control device that executes control related to a token, a computer-readable, non-transitory recording medium having a token control program recorded thereon, and a system.

A system is known that provides a sandbox environment, and a production environment.

### SUMMARY

The disclosure proposes further improvement of the foregoing techniques.

In an aspect, the disclosure provides a token control device including a storage device and a control device. In the storage device, a token control program is stored. The control device includes a processor, and acts as a token controller when the processor executes the token control program. When a client requests permission for a user to log in to an application provision device that provides applications, each having an application ID, serving as identification information and different in each of environments, and the permission to log in is granted, the token controller notifies a token to the client, and associates the application ID of the application and a URL for making access to the application, with the token, with respect to each of the application IDs, and when an application utilization instruction, instructing to utilize the application, and including the token and the application ID, is transmitted from the client, the token controller notifies the token included in the application utilization instruction and the URL associated with the application ID, to the client.

In another aspect, the disclosure provides a computer-readable, non-transitory recording medium having a token control program recorded thereon. The token control program causes a computer to act as a token controller that notifies, when a client requests the computer to permit a user to log in to an application provision device that provides applications, each having an application ID, serving as identification information and different in each of environments, and the permission to log in is granted, a token to the client, and associates the application ID of the application and a URL for making access to the application, with the token, with respect to each of the application IDs, and notifies, when an application utilization instruction, instructing to utilize the application, and including the token and the application ID, is transmitted from the client to the computer, the token included in the application utilization instruction and the URL associated with the application ID, to the client.

In still another aspect, the disclosure provides a system including a token control device, a cache device, and an application provision device. The token control device executes control related to a token. The cache device retains the token. The application provision device provides applications, each having an application ID, serving as identification information and different in each of environments. When a client requests permission for a user to log in to the application provision device, and the permission to log in is granted, the token control device notifies the token to the client, and stores the application ID of the application and a URL for making access to the application, in the cache device in association with the token, with respect to each of the application IDs, and when an application utilization instruction, instructing to utilize the application, and including the token and the application ID, is transmitted from the client, the token control device notifies the token included in the application utilization instruction and the URL stored in the cache device in association with the application ID, to the client.

### BRIEF DESCRIPTION OF THE DRAWINGS

FIG. 1 is a block diagram showing an example of a system according to a first embodiment of the disclosure;

FIG. 2 is a block diagram showing an example of the token control device shown in FIG. 1, constituted of a single computer;

FIG. 3 is a block diagram showing an example of the cache device shown in FIG. 1, constituted of a single computer;

FIG. 4 is a table showing an example of data of a key-value format for managing a token;

FIG. 5 is a block diagram showing an example of the application provision device shown in FIG. 1, constituted of a single computer;

FIG. 6 is a table showing an example of the tenant management information shown in FIG. 5;

FIG. 7 is a table showing an example of the user management information shown in FIG. 5;

FIG. 8 is a table showing an example of the application management information shown in FIG. 5;

FIG. 9 is a block diagram showing an example of the client shown in FIG. 1, constituted of a PC;

FIG. 10 is a sequence chart showing an operation of the system shown in FIG. 1, performed when a user logs in to the application provision device via the client;

FIG. 11 is a schematic drawing showing an example of the log-in screen, displayed in the process shown in FIG. 10;

FIG. 12 is a sequence chart showing an operation of the system shown in FIG. 1, performed when an application provided by the application provision device is utilized by the client;

FIG. 13 is a schematic drawing showing an example of the application utilization screen, displayed in the process shown in FIG. 12;

FIG. 14 is a flowchart specifying the URL identification process shown in FIG. 12;

FIG. 15 is a table showing an example of data of the key-value format for managing the token, according to a second embodiment;

FIG. 16 is a table showing an example of the application management information, utilized in the second embodiment;

FIG. 17 is a schematic drawing showing an example of an application utilization screen, according to the second embodiment;

FIG. 18 is a flowchart specifying the URL identification process, according to the second embodiment;

FIG. 19 is a table showing an example of data of the key-value format for managing the token, according to a third embodiment;

FIG. 20 is a sequence chart showing an operation of the system, performed when property reproduction setting is changed;

FIG. 21 is a sequence chart showing an operation of the system according to the third embodiment, performed when the application provided by the application provision device is utilized by the client; and

FIG. 22 is a flowchart specifying the property reproduction process shown in FIG. 21.

### DETAILED DESCRIPTION

Hereafter, a token control device that executes the control related to a token, a computer-readable, non-transitory recording medium having a token control program recorded thereon, and a system, according to some embodiments of the disclosure, will be described with reference to the drawings.

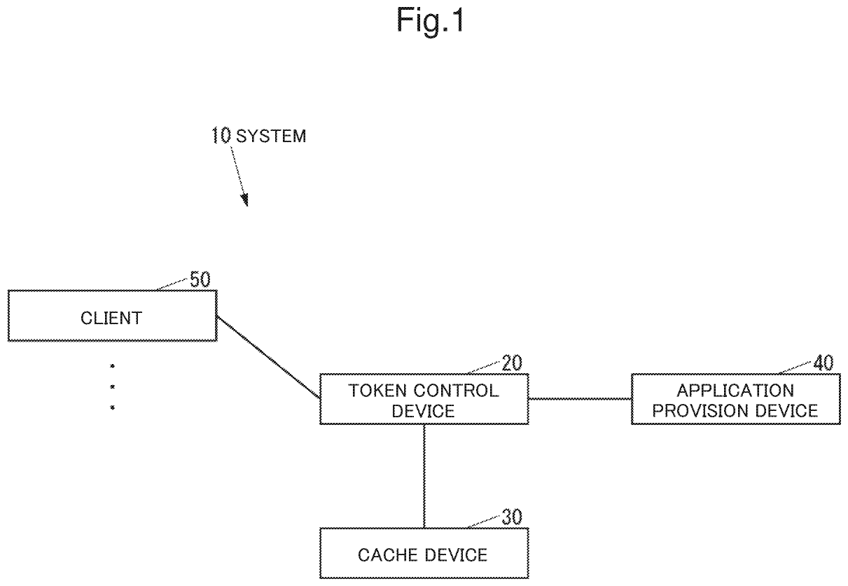

First, a configuration of a system according to a first embodiment of the disclosure will be described. FIG. 1 is a block diagram showing an example of a system 10, according to the first embodiment. The system 10 includes a token control device 20, an application provision device 40, and a cache device 30.

As shown in FIG. 1, the system 10 includes the token control device 20 that executes control related to a token. The token control device 20 may be constituted of a single computer such as a personal computer (PC), or a plurality of computers. The token control device 20 may be provided on a cloud.

The system 10 includes a cache device 30 that retains the token. The cache device 30 may be constituted of a single computer such as a PC, or a plurality of computers. At least a part of the computers constituting the token control device 20 may also serve as at least a part of the computers constituting the cache device 30. The cache device 30 may be provided on a cloud.

The system 10 includes an application provision device 40 that provides applications. The applications provided by the application provision device 40 may be a Web application to be operated by a user, or a Web service that releases the application programming Interface (API) to be utilized by the Web application or the Web service. The application provision device 40 may be constituted of a single computer such as a PC, or a plurality of computers. At least a part of the computers constituting the token control device 20 may also serve as at least a part of the computers constituting the application provision device 40. At least a part of the computers constituting the cache device 30 may also serve as at least a part of the computers constituting the application provision device 40. The application provision device 40 may be provided on a cloud.

The system 10 can be accessed by a client 50, acting as a user terminal to be used by the user. The system 10 can be accessed by clients configured similarly to the client 50, in addition to the client 50. The client 50 is, for example, constituted of an information processing device such as a PC, a tablet, or a smartphone.

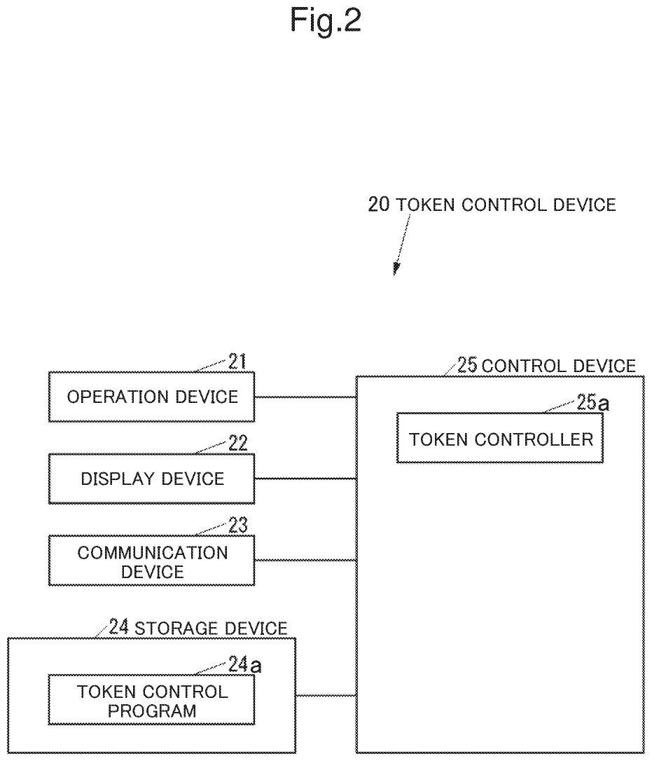

FIG. 2 is a block diagram showing an example of the token control device 20, constituted of a single computer.

As shown in FIG. 2, the token control device 20 includes an operation device 21 including, for example, a keyboard and a mouse for inputting various operations, a display device 22, for example including a liquid crystal display (LCD) for displaying various types of information, a communication device 23 that performs communication with an external device, via a network such as a local area network (LAN) or the internet, or directly through wired or wireless communication, a storage device 24 including a non-volatile memory unit such as a semiconductor memory or a hard disk drive (HDD), for storing various types of information, and a control device 25 that controls the overall operation of the token control device 20.

The storage device 24 contains a token control program 24a for controlling the token. The token control program 24a may be, for example, installed in the token control device 20 during the manufacturing process thereof, additionally installed in the token control device 20 from an external storage medium such as a universal serial bus (USB) memory, or additionally installed in the token control device 20 from a network.

The control device 25 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The processor exemplifies the computer. The processor of the control device 25 executes the programs stored in the storage device 24 or the ROM of the control device 25.

The control device 25 acts as a token controller 25a that executes control related to the token, by executing the token control program 24a stored in the storage device 24.

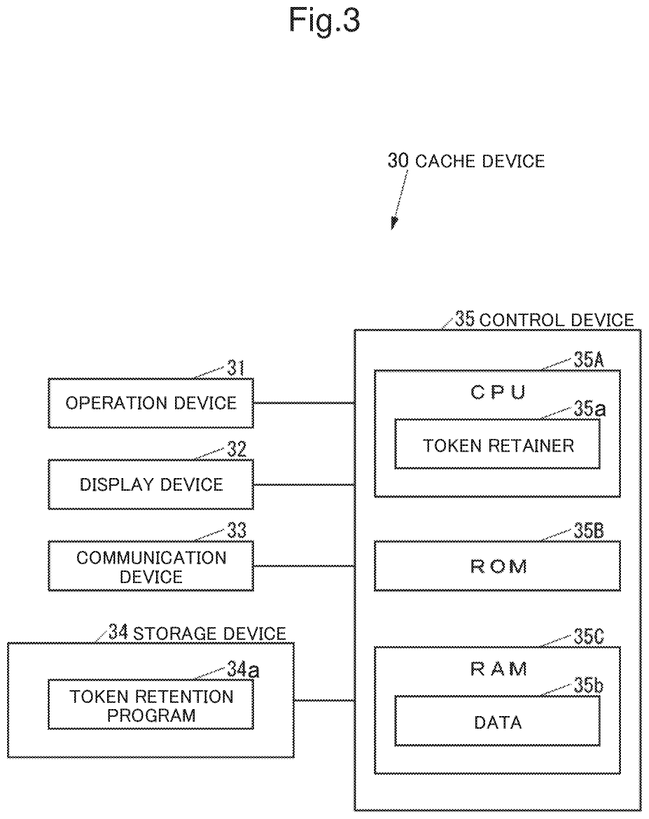

FIG. 3 is a block diagram showing the cache device 30, constituted of a single computer.

As shown in FIG. 3, the cache device 30 includes an operation device 31 including, for example, a keyboard and a mouse for inputting various operations, a display device 32, for example including an LCD for displaying various types of information, a communication device 33 that performs communication with an external device, via a network such as a LAN or the internet, or directly through wired or wireless communication, a storage device 34 including a non-volatile memory unit such as a semiconductor memory or an HDD, for storing various types of information, and a control device 35 including a control circuit that controls the overall operation of the cache device 30.

The storage device 34 contains a token retention program 34a for retaining the token. The token retention program 34a may be, for example, installed in the cache device 30 during the manufacturing process thereof, additionally installed in the cache device 30 from an external storage medium such as a USB memory, or additionally installed in the cache device 30 from the network.

The control device 35 includes, for example, a CPU 35A exemplifying the processor, a ROM 35B containing programs and various types of data, and a RAM 35C serving as the operation region for the CPU 35A of the control device 35. The CPU 35A of the control device 35 executes the programs stored in the storage device 34 or the ROM 35B of the control device 35.

The CPU 35A acts as a token retainer 35a, when the processor operates according to the token retention program 34a stored in the storage device 34.

The RAM 35C stores therein data 35b of a key-value format, for managing the token.

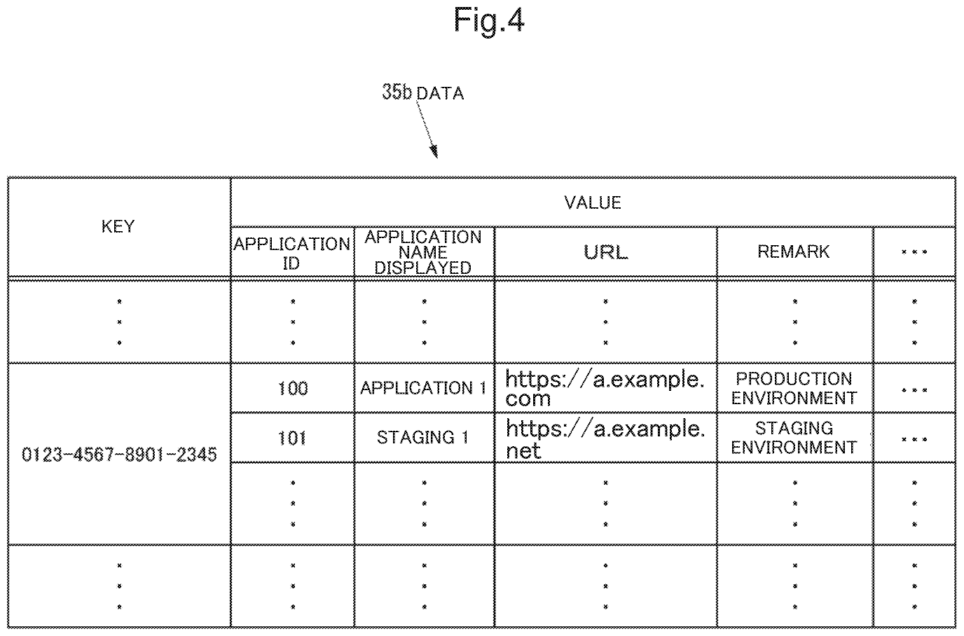

FIG. 4 is a table showing an example of the data 35b. As shown in FIG. 4, the data 35b includes the token as the key. The data 35b includes the information about the user to whom the token is applicable, as the value. The information about the user includes, for example, an application ID serving as the identification information of the application provided by the application provision device 40, the name of the application displayed in the application provision device 40 (hereinafter, “application name displayed”), a uniform resource locator (URL) for making access to the application, and a remark about the application, with respect to each of the application IDs. The information about the user may be the information of a document format, such as JavaScript object notation (JSON) format, or extensible markup language (XML) format.

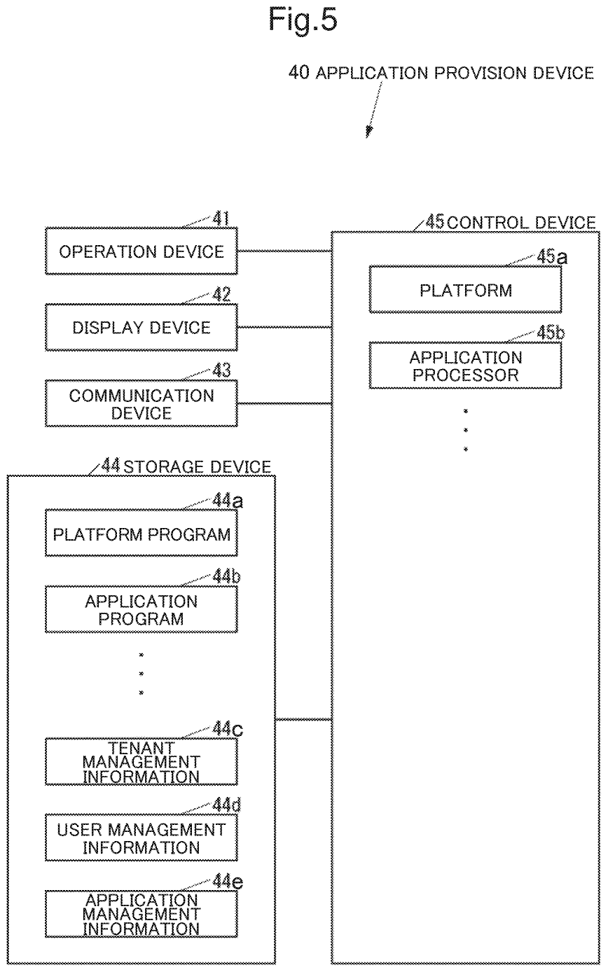

FIG. 5 is a block diagram showing a configuration of the application provision device 40, constituted of a single computer.

As shown in FIG. 5, the application provision device 40 includes an operation device 41 including, for example, a keyboard and a mouse for inputting various operations, a display device 42, for example including an LCD for displaying various types of information, a communication device 43 that performs communication with an external device, via a network such as a LAN or the internet, or directly through wired or wireless communication, a storage device 44 including a non-volatile memory unit such as a semiconductor memory or an HDD, for storing various types of information, and a control device 45 including a control circuit that controls the overall operation of the application provision device 40.

The storage device 44 stores therein a program for realizing the platform on which the application is executed (hereinafter, “platform program”) 44a. The platform program 44a may be, for example, installed in the application provision device 40 during the manufacturing process thereof, additionally installed in the application provision device 40 from an external storage medium such as a universal serial bus (USB) memory, or additionally installed in the application provision device 40 from a network.

The storage device 44 stores therein a plurality of programs for realizing the application (hereinafter, “application program”). For example, the storage device 44 stores therein an application program 44b. The application programs may be manufactured by a manufacturer different from that of the application provision device 40. The application program may be, for example, installed in the application provision device 40 during the manufacturing process thereof, additionally installed in the application provision device 40 from an external storage medium such as a universal serial bus (USB) memory, or additionally installed in the application provision device 40 from a network.

The storage device 44 stores therein a tenant management information 44c for managing the tenants of the application provision device 40.

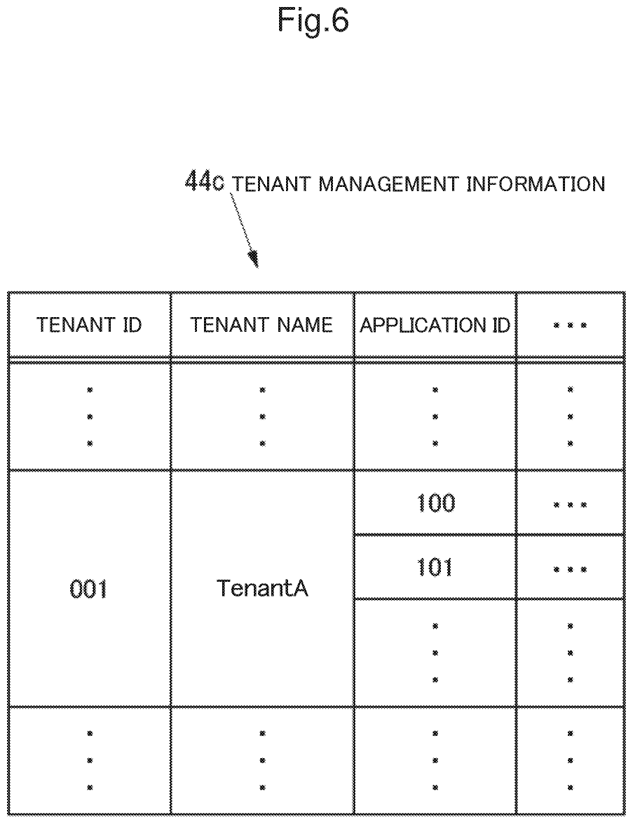

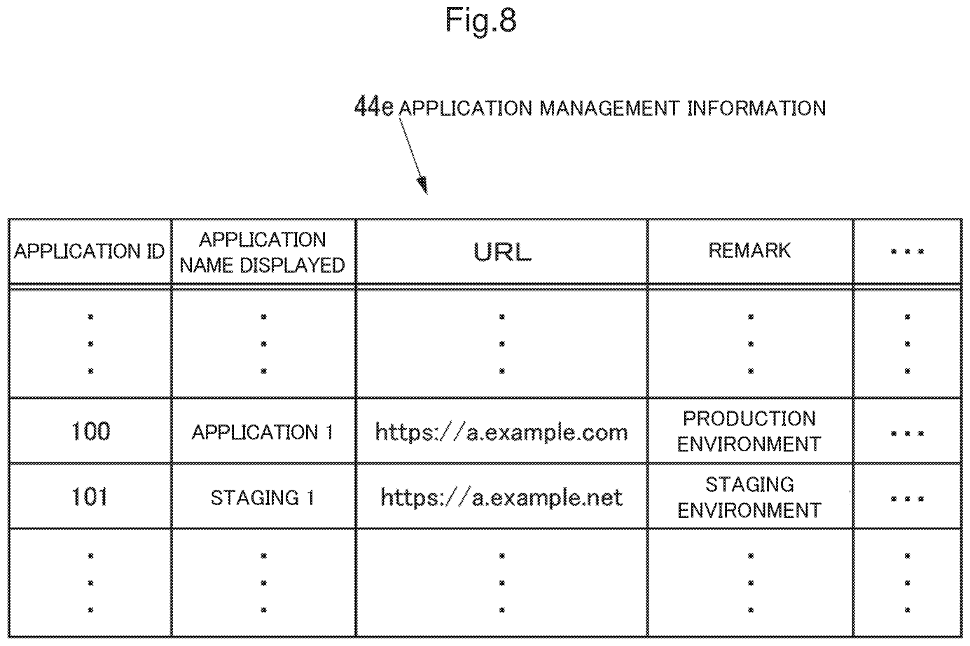

FIG. 6 is a table showing an example of the tenant management information 44c. As shown in FIG. 8, the tenant management information 44c includes the tenant ID serving as the identification information of the tenant, the tenant name representing the name of the tenant, and the application ID, with respect to each of the tenants. In the tenant management information 44c, a plurality of application IDs may be associated with each of the tenant IDs. The tenant management information 44c shown in FIG. 6 only shows a part of specific values.

As shown in FIG. 5, the storage device 44 stores therein a user management information 44d for managing the users of the application provision device 40.

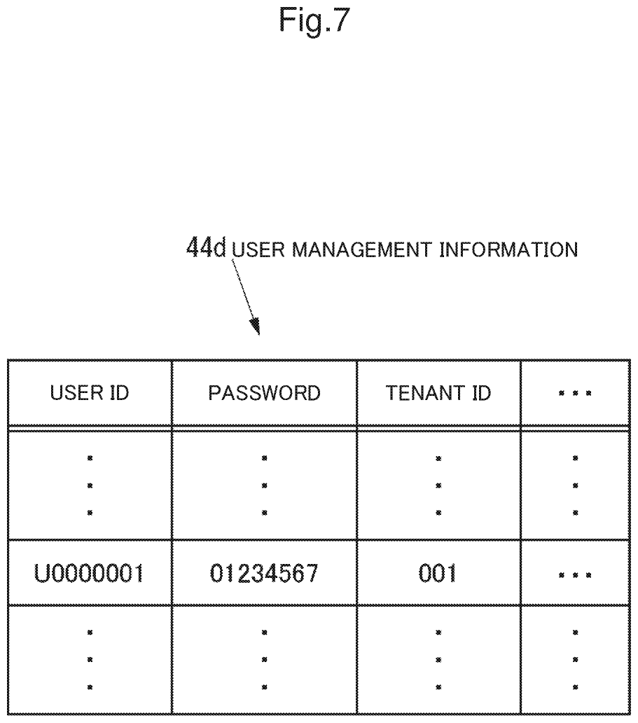

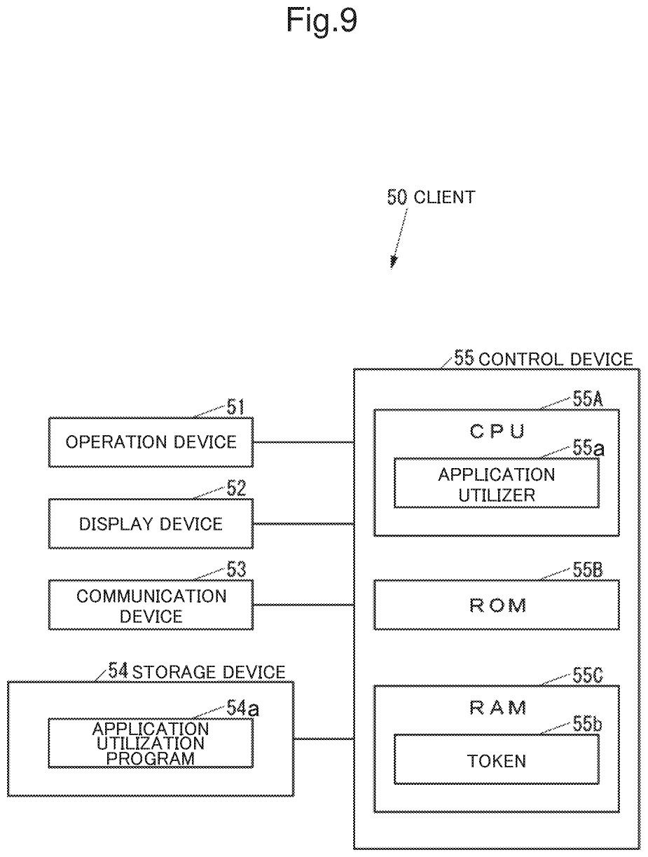

FIG. 7 is a table showing an example of the user management information 44d. As shown in FIG. 9, the user management information 44d includes the user ID serving as the identification information of the user, the password of the user, and the tenant ID of the tenant to which the user belongs, with respect to each of the users. The user management information 44d shown in FIG. 7 only shows a part of specific values.

As shown in FIG. 5, the storage device 44 stores therein application management information 44e, for managing the application provided by the application provision device 40.

FIG. 8 is a table showing an example of the application management information 44e. As shown in FIG. 8, the application management information 44e includes the application ID, the application name displayed, the URL, and the remark, with respect to each of the application IDs. In FIG. 8, the application having the application ID “100” is in a production environment, and the application having the application ID “101” is in a staging environment. The application having the application ID “100” and the application having the application ID “101” are different only in the serving environment, and the configuration of those applications are identical.

The control device 45 shown in FIG. 5 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The processor exemplifies the computer. The processor of the control device 45 executes the programs stored in the storage device 44 or the ROM of the control device 45.

The control device 45 acts as the platform 45a, when the processor operates according to the platform program 44a. The platform 45a releases the API utilized by the application.

The control device 45 acts as an application processor 45b, when the processor operates according to the application program.

FIG. 9 is a block diagram showing a configuration of the client 50, constituted of a PC. As shown in FIG. 9, the client 50 includes an operation device 51 including, for example, a keyboard and a mouse for inputting various operations, a display device 52, for example including an LCD for displaying various types of information, a communication device 53 that performs communication with an external device, via a network such as a LAN or the internet, or directly through wired or wireless communication, a storage device 54 including a non-volatile memory unit such as a semiconductor memory or an HDD, for storing various types of information, and a control device 55 that controls the overall operation of the client 50.

The storage device 54 stores therein a program for utilizing the application (hereinafter, “application utilization program”) 54a. The application utilization program 54a may be, for example, installed in the client 50 during the manufacturing process thereof, additionally installed in the client 50 from an external storage medium such as a universal serial bus (USB) memory, or additionally installed in the client 50 from a network.

The controller 55 includes, for example, a CPU 55A exemplifying the processor, a ROM 55B containing programs and various types of data, and a RAM 55C serving as the operation region for the CPU 55A of the control device 55. The CPU 55A of the control device 55 executes the programs stored in the storage device 54 or the ROM 55B of the control device 55.

The CPU 55A of the control device 55 acts as an application utilizer 55a, when the processor operates according to the application utilization program 54a stored in the storage device 54.

The RAM 55C stores therein the token 55b.

Hereunder, an operation of the system 10 will be described. First, an operation of the system 10, performed when the user logs in to the application provision device 40, will be described.

The following description represents the case where the user logs in to the application provision device 40 via the client 50.

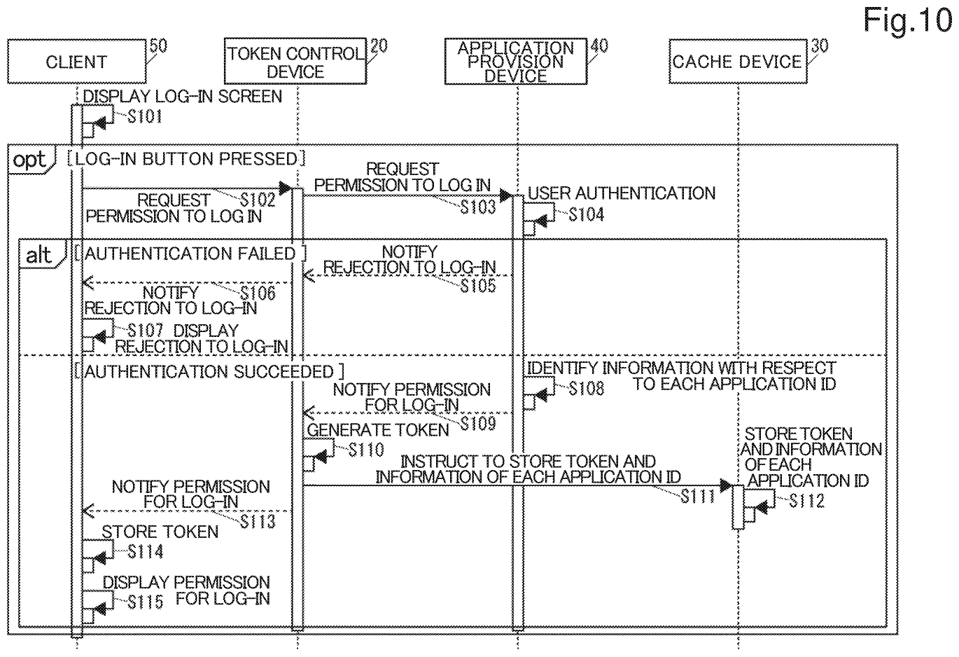

FIG. 10 is a sequence chart showing an operation of the system 10, performed when the user logs in to the application provision device 40 via the client 50.

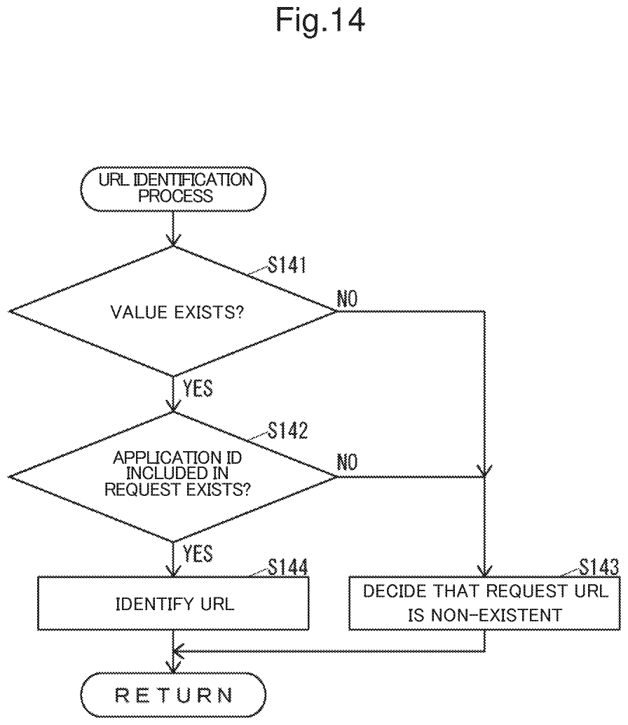

The user inputs an instruction to display a screen for logging in to the application provision device 40 (hereinafter, “log-in screen”), to the operation device 51 of the client 50. When the instruction to display the log-in screen is inputted to the operation device 51 of the client 50, the application utilizer 55a of the client 50 causes the display device 52 to display a log-in screen 900 (see FIG. 14) (S101).

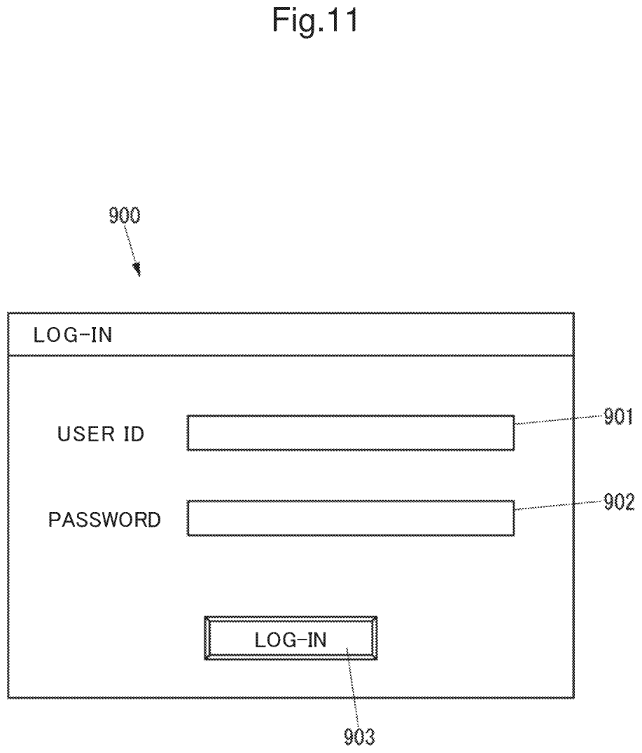

FIG. 11 is a schematic drawing showing an example of the log-in screen 900. As shown in FIG. 11, the log-in screen 900 includes a textbox 901 which is a widget for inputting the user ID, a textbox 902 which is a widget for inputting the password, and a log-in button 903 for inputting the instruction to log in to the application provision device 40. The operation device 51 accepts the log-in instruction inputted through the log-in button 903, only when the value is inputted to both of the textbox 901 and the textbox 902.

After finishing the operation of S101, as shown in FIG. 10, when the instruction to log in is inputted to the operation device 51 through the log-in button 903 in the log-in screen 900, the application utilizer 55a of the client 50 requests the token control device 20 to permit the log-in, with the combination of the user ID inputted to the textbox 901 at the time that the log-in instruction was inputted, and the password inputted to the textbox 902 at the time that the log-in instruction was inputted (S102). The application utilizer 55a includes the combination of the user ID inputted to the textbox 901 at the time that the log-in instruction was inputted, and the password inputted to the textbox 902 at the time that the log-in instruction was inputted, in the request of S102.

Upon receipt of the request of S102, the token controller 25a of the token control device 20 requests the application provision device 40 to permit the log-in requested at S102 (S103). The token controller 25a includes the combination of the user ID and the password included in the request of S102, in the request of S103.

Upon receipt of the request of S102, the platform 45a of the application provision device 40 performs authentication of the user corresponding to the request of S103 (S104). To be more specific, when the combination of the user ID and the password included in the request of S103 is included in the user management information 44d, the platform 45a permits the user to log in. In contrast, when the combination of the user ID and the password included in the request of S103 is not included in the user management information 44d, the platform 45a does not permit the user to log in.

Upon deciding that the authentication performed at S104 has failed, the platform 45a notifies the token control device 20 that the log-in has been rejected (S105).

Upon receipt of the notice of S105, the token controller 25a of the token control device 20 notifies the client 50 that the log-in has been rejected (S106).

Upon receipt of the notice of S106, the application utilizer 55a of the client 50 displays a message indicating that the log-in has been rejected, on the display device 52 of the client 50 (S107).

Upon permitting the user to log in at S104, the platform 45a of the application provision device 40 identifies the application name displayed, the URL, and the remark, on the basis of the application management information 44e, with respect to each of the application IDs, associated in the tenant management information 44c with the tenant ID associated with the user ID used for the authentication of S104, in the user management information 44d (S108).

After finishing the operation of S108, the platform 45a notifies the token control device 20 that the log-in has been permitted (S109). At the same time, the platform 45a includes the application name displayed, the URL, and the remark of each of the application IDs, identified at S108, in the notice of S109.

Upon receipt of the notice of S109, the token controller 25a of the token control device 20 generates the token (S110).

After finishing the operation of S110, the token controller 25a instructs the cache device 30 to store the data including the token generated at S110 as the key, and the application name displayed, the URL, and the remark of each of the application IDs, included in the notice of S109, as the value (S111).

Upon receipt of the instruction of S111, the token retainer 35a of the cache device 30 stores the data according to the instruction of S111, in the RAM 35C (S112).

After finishing the operation of S111, the token controller 25a of the token control device 20 notifies the client 50 that the log-in has been permitted (S113). The token controller 25a includes the token generated at S110, in the notice of S113.

Upon receipt of the notice of S113, the application utilizer 55a of the client 50 stores the token included in the notice of S113, in the RAM 55C as a token 55b (S114).

After finishing the operation of S114, the application utilizer 55a displays the permission to log in, on the display device 52 of the client 50 (S115).

Hereunder, an operation of the system 10, performed when the application provided by the application provision device 40 is utilized by the client, will be described.

The following description represents the operation performed by the system 10, when the application provided by the application provision device 40 is utilized by the client 50.

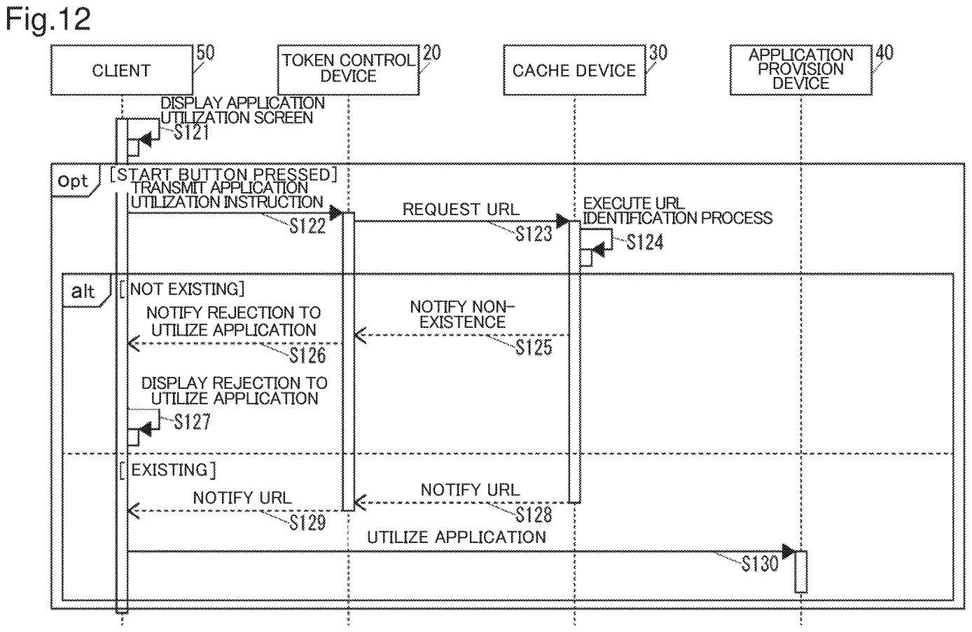

FIG. 12 is a sequence chart showing an operation of the system 10, performed when the application provided by the application provision device 40 is utilized by the client 50.

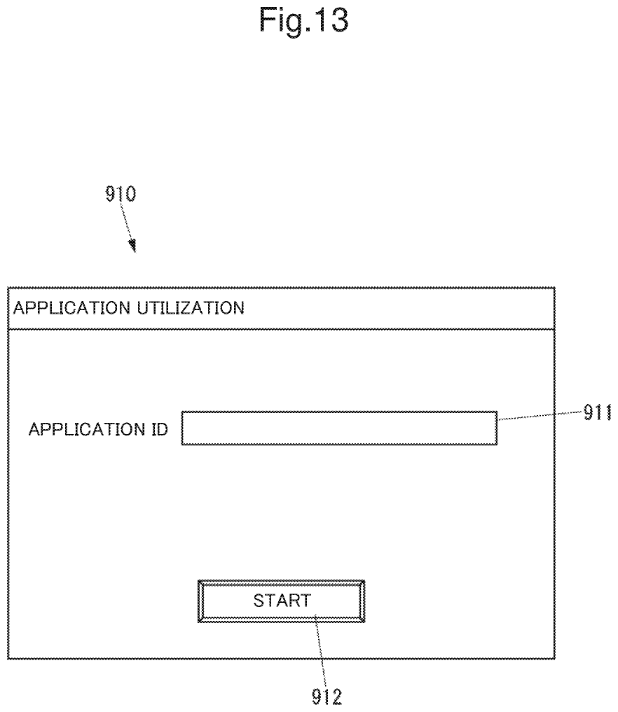

In the logged-in state to the application provision device 40 via the client 50, the user can instruct the client 50, via the operation device 51 thereof, to display a screen for utilizing the application provided by the application provision device 40 (hereinafter, “application utilization screen”). Upon receipt of the instruction to display the application utilization screen, the application utilizer 55a of the client 50 displays an application utilization screen 910 (see FIG. 13) on the display device 52 of the client 50, as shown in FIG. 12 (S121).

FIG. 13 is a schematic drawing showing an example of the application utilization screen 910. The application utilization screen 910 shown in FIG. 13 includes a textbox 911 which is a widget for inputting the application ID of the application that the user wishes to utilize, and a start button 912 which is a widget for starting to utilize the application. The start button 912 can only be pressed, when a value is inputted to the textbox 911.

As shown in FIG. 12, when the start button 912 is pressed, the application utilizer 55a of the client 50 transmits an instruction to utilize the application (hereinafter, “application utilization instruction”) to the token control device 20 (S122). The application utilizer 55a includes the token 55b stored in the RAM 55C, and the application ID inputted to the textbox 911 at the time that the start button 912 was pressed, in the application utilization instruction.

Upon receipt of the application utilization instruction transmitted at S122, the token controller 25a of the token control device 20 requests the cache device 30 to provide the URL associated with the application ID included in the application utilization instruction, in the value the key of which is the token included in the application utilization instruction (S123).

Upon receipt of the request of S123, the token retainer 35a of the cache device 30 identifies the URL requested at S123 (hereinafter, “URL identification process”).

FIG. 14 is a flowchart specifying the URL identification process shown in FIG. 12. As shown in FIG. 14, the token retainer 35a decides whether there are any values, the key of which is the token included in the request of S123 (S141).

Upon deciding at S141 that there are one or more values the key of which is the token included in the request of S123, the token retainer 35a decides whether the value, the key of which is the token included in the request of S123, includes the application ID included in the request of S123 (S142).

Upon deciding at S141 that there is no value the key of which is the token included in the request of S123, or deciding at S142 that the value, the key of which is the token included in the request of S123, does not include the application ID included in the request of S123, the token retainer 35a decides that the URL requested at S123 is not included in the data stored in the RAM 35C (S143).

Upon deciding at S142 that the value, the key of which is the token included in the request of S123, includes the application ID included in the request of S123, the token retainer 35a identifies the URL corresponding to the application ID included in the request of S123, in the value the key of which is the token included in the request of S123 (S144). In other words, the token retainer 35a decides that the URL requested at S123 is included in the data stored in the RAM 35C.

After finishing the operation of S143 or S144, the token retainer 35a finishes the URL identification process specified in FIG. 14.

As shown in FIG. 12, upon deciding through the URL identification process of S124, that the URL requested at S123 is not included in the data stored in the RAM 35C, the token retainer 35a notifies the token control device 20 that the URL requested at S123 is non-existent (S125).

Upon receipt of the notice of S125, the token controller 25a of the token control device 20 notifies the client 50 that the utilization of the application has been rejected (S126).

Upon receipt of the notice of S126, application utilizer 55a of the client 50 displays a message indicating that the utilization of the application has been rejected, on the display device 52 (S127).

Upon deciding, through the URL identification process of S124, that the URL requested at S123 is included in the data stored in the RAM 35C, the token retainer 35a of the cache device 30 notifies the URL identified through the URL identification process of S124, to the token control device 20 (S128).

Upon receipt of the notice of S128, the token controller 25a of the token control device 20 notifies the URL notified at S128, to the client 50 (S129).

Upon receipt of the notice of S129, the application utilizer 55a of the client 50 makes access to the URL included in the notice, and starts the application utilization process, thus utilizing the application corresponding to the application ID included in the application utilization instruction (S130).

According to the first embodiment, as described above, the token control device retains the application ID of the application, different in each of the environments, and the URL for making access to the application, in association with the token to be notified to the client, with respect to each of the application IDs. When the application utilization instruction, including the token and the application ID, is transmitted at S122 from the client, the token control device notifies the token and the URL associated with the application ID, to the client. At this point, the operation of identifying the URL associated with the combination of the token and the application ID, at the time that the application is utilized, without fixedly embedding the URL inherent to the environment in the token itself, is executed on the side of the token control device. Therefore, the difference in environment is absorbed by switching the reference table including the URL associated with the combination of the token and the application ID, and consequently the same token can be utilized without depending on the environment of the application.

Hereunder, the system 10 according to a second embodiment of the disclosure will be described. Regarding the second embodiment, the description of the elements or operations similar to those of the first embodiment will not be repeated. In other words, the configuration and operation of the token control device 20, the cache device 30, the application provision device 40, and the client 50 of the system 10 according to the second embodiment are similar to those of the first embodiment, unless otherwise specifically noted.

In the second embodiment, when the client requests permission for the user to log in to the application provision device, and the permission to log in is granted, the token controller notifies the token to the client, and associates the application ID and the version of the application, and the URL for making access to the application, with the token, with respect to each of the combinations of the application ID and the version, and when the application utilization instruction, instructing to utilize the application, and including the token, the application ID, and the version, is transmitted from the client, the token controller notifies the token included in the application utilization instruction, and the URL associated with the application ID and the version, to the client.

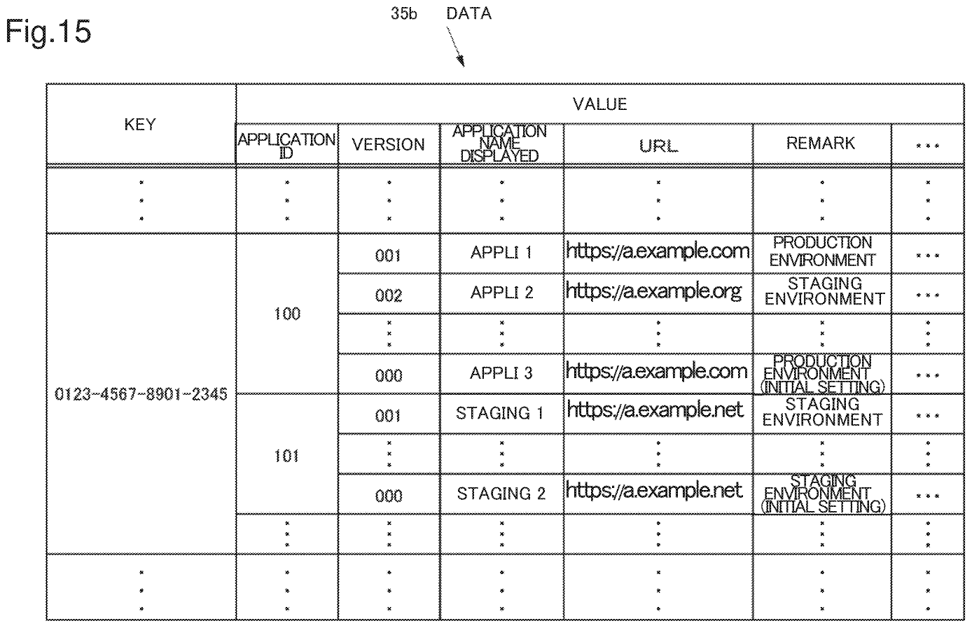

The data 35b used in the second embodiment will be described hereunder. FIG. 15 is a table showing an example of the data 35b. As shown in FIG. 15, the data 35b includes the token as the key. The data 35b includes the information about the user to whom the token is applicable, as the value. The information about the user includes, for example, the application ID serving as the identification information of the application provided by the application provision device 40, the version of the application, the application name displayed in the application provision device 40, the URL for making access to the application, and the remark about the application, with respect to each of the application IDs.

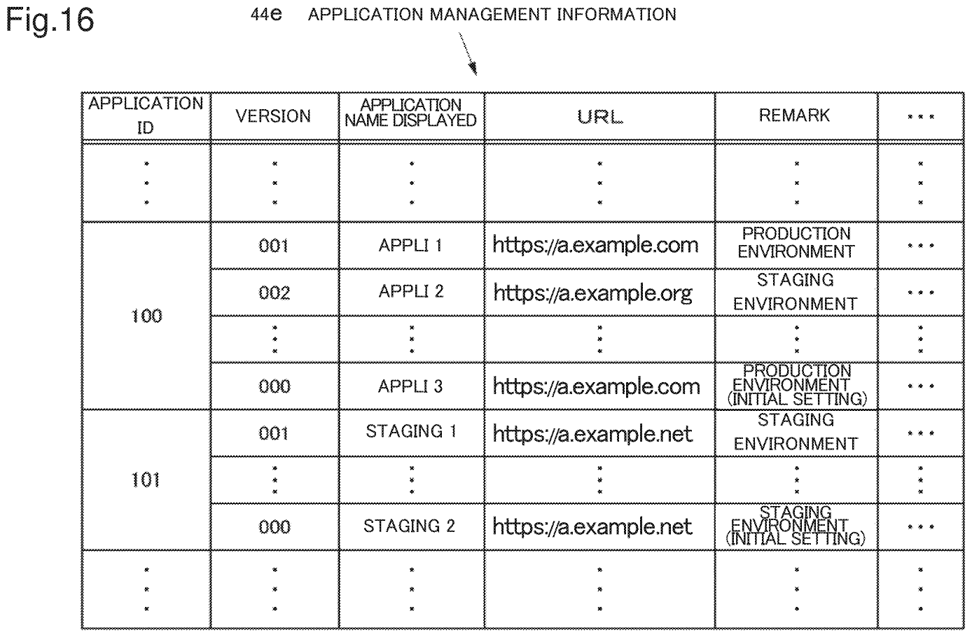

The application management information 44e used in the second embodiment will be described hereunder. FIG. 16 is a table showing an example of the application management information 44e.

As shown in FIG. 16, the application management information 44e includes the application ID, the version, the application name displayed, the URL, and the remark, with respect to each of the application IDs. In FIG. 16, the application having the application ID “100” and the version of which is “000” or “001”, is the application in the production environment, and the application having the application ID “101” and the version of which is “002”, and the application having the application ID “101” and the version of which is “000” or “001”, are the applications in the staging environment. The application having the application ID “100” and the application having the application ID “101” are different only in the serving environment, and the configuration of those applications are identical, when the version is the same.

Referring again to FIG. 10, the operation of the system 10 according to the second embodiment, performed when the user logs in to the application provision device 40 via the client 50 will be described hereunder.

In the second embodiment, upon deciding that the authentication performed at S104 has succeeded, the platform 45a of the application provision device 40 identifies the version, the application name displayed, the URL, and the remark, on the basis of the application management information 44e, with respect to each of the application IDs, associated in the tenant management information 44c with the tenant ID associated with the user ID used for the authentication of S104, in the user management information 44d (S108).

After finishing the operation of S108, the platform 45a notifies the token control device 20 that the log-in has been permitted (S109). At the same time, the platform 45a includes the version, the application name displayed, the URL, and the remark of each of the application IDs, identified at S108, in the notice of S109.

After finishing the operation of S110, the token controller 25a instructs the cache device 30 to store the data including the token generated at S110 as the key, and the version, the application name displayed, the URL, and the remark of each of the application IDs, included in the notice of S109, as the value (S111).

The operation performed by the system 10, when the application provided by the application provision device 40 is utilized by the client 50, according to the second embodiment, will be described with reference to FIG. 12.

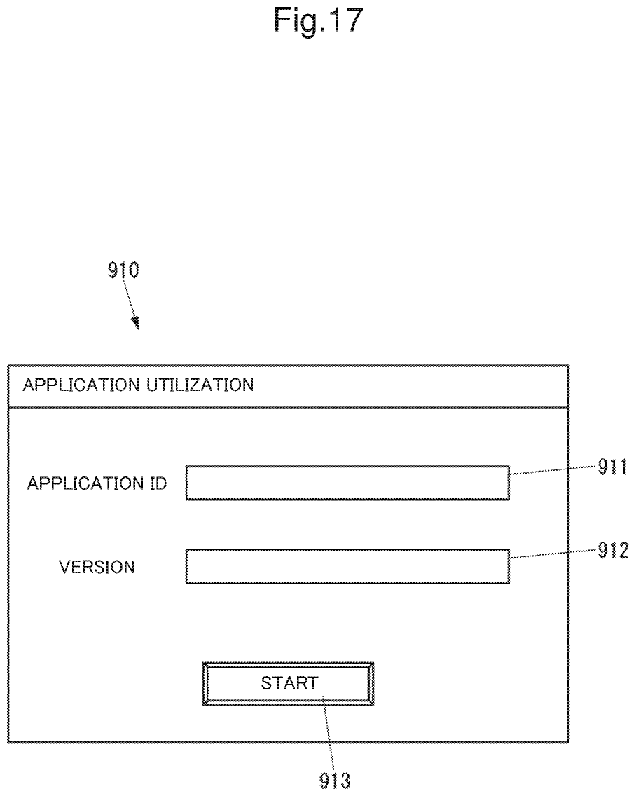

In the logged-in state to the application provision device 40 via the client 50, the user can instruct the client 50, via the operation device 51 thereof, to display the screen for utilizing the application provided by the application provision device 40 (hereinafter, “application utilization screen”). Upon receipt of the instruction to display the application utilization screen, the application utilizer 55a of the client 50 displays the application utilization screen 910 (see FIG. 17 referred to below) on the display device 52 of the client 50 (S121).

FIG. 17 is a schematic drawing showing an example of the application utilization screen 910. The application utilization screen 910 shown in FIG. 17 includes a textbox 911 which is a widget for inputting the application ID of the application that the user wishes to utilize, a textbox 912 which is a widget for inputting the version of the application that the user wishes to utilize, and a start button 913 which is a widget for starting to utilize the application. The start button 913 can only be pressed, when a value is inputted to the textbox 911.

As shown in FIG. 12, when the start button 913 is pressed, the application utilizer 55a of the client 50 transmits an instruction to utilize the application (hereinafter, “application utilization instruction”) to the token control device 20 (S122). The application utilizer 55a includes the token 55b stored in the RAM 55C, and the application ID inputted to the textbox 911 at the time that the start button 913 was pressed, in the application utilization instruction. In the case where a value was inputted to the textbox 912 at the time that the start button 913 was pressed, the application utilizer 55a also includes the version inputted to the textbox 912 when the start button 913 was pressed, in the application utilization instruction.

Upon receipt of the application utilization instruction transmitted at S122, the token controller 25a of the token control device 20 requests the cache device 30 to provide the URL associated with the application ID included in the application utilization instruction, in the value the key of which is the token included in the application utilization instruction (S123).

Upon receipt of the request of S123, the token retainer 35a of the cache device 30 identifies the URL requested at S123 (hereinafter, “URL identification process”).

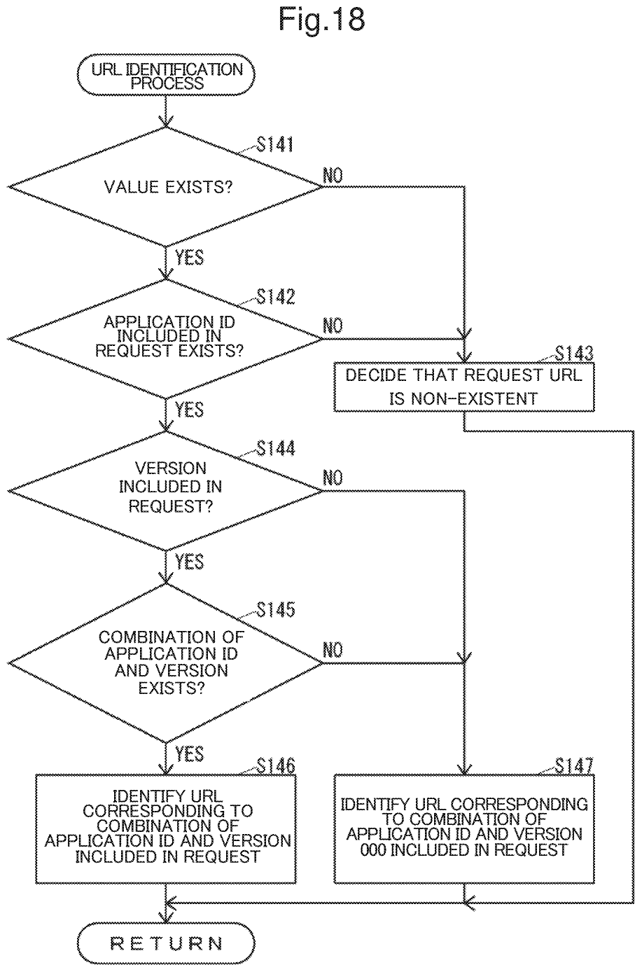

The URL identification process according to the second embodiment will be described hereunder. FIG. 18 is a flowchart specifying the URL identification process according to the second embodiment.

As shown in FIG. 18, the token retainer 35a decides whether there are any values, the key of which is the token included in the request of S123 (S141).

Upon deciding at S141 that there are one or more values the key of which is the token included in the request of S123, the token retainer 35a decides whether the value, the key of which is the token included in the request of S123, includes the application ID included in the request of S123 (S142).

Upon deciding at S141 that there is no value the key of which is the token included in the request of S123, or deciding at S142 that the value, the key of which is the token included in the request of S123, does not include the application ID included in the request of S123, the token retainer 35a decides that the URL requested at S123 is not included in the data stored in the RAM 35C (S143).

Upon deciding at S142 that the value, the key of which is the token included in the request of S123, includes the application ID included in the request of S123, the token retainer 35a decides whether the version is included in the request of S123 (S144).

Upon deciding at S144 that the version is included in the request of S123, the token retainer 35a decides whether the value, the key of which is the token included in the request of S123, includes the combination of the application ID and the version included in the request of S123 (S145).

Upon deciding at S145 that the value, the key of which is the token included in the request of S123, includes the combination of the application ID and the version included in the request of S123, the token retainer 35a identifies the URL associated with the combination of the application ID and the version included in the request of S123, in the value the key of which is the token included in the request of S123 (S146). In other words, the token retainer 35a decides that the URL requested at S123 is included in the data stored in the RAM 35C.

Upon deciding at S144 that the version is not included in the request of S123, or deciding at S145 that the value, the key of which is the token included in the request of S123, does not include the combination of the application ID and the version included in the request of S123, the token retainer 35a identifies the URL corresponding to the combination of the application ID and the version “000” included in the request of S123, in the value the key of which is the token included in the request of S123 (S147).

After finishing the operation of S143, S146, or S147, the token retainer 35a finishes the URL identification process specified in FIG. 18.

As shown in FIG. 12, upon deciding through the URL identification process of S124, that the URL requested at S123 is not included in the data stored in the RAM 35C, the token retainer 35a notifies the token control device 20 that the URL requested at S123 is non-existent (S125).

Upon receipt of the notice of S125, the token controller 25a of the token control device 20 notifies the client 50 that the utilization of the application has been rejected (S126).

Upon receipt of the notice of S126, application utilizer 55a of the client 50 displays a message indicating that the utilization of the application has been rejected, on the display device 52 (S127).

Upon deciding, through the URL identification process of S124, that the URL requested at S123 is included in the data stored in the RAM 35C, the token retainer 35a of the cache device 30 notifies the URL identified through the URL identification process of S124, to the token control device 20 (S128).

Upon receipt of the notice of S128, the token controller 25a of the token control device 20 notifies the URL notified at S128, to the client 50 (S129).

Upon receipt of the notice of S129, the application utilizer 55a of the client 50 utilizes the application corresponding to the application ID included in the application utilization instruction, by making access to the URL notified at S129 (S130).

According to the second embodiment, as described above, the same token can be utilized without depending on the environment of the application, even in the case where the token control device 20 associates the application ID and the version of the application, different in each of the environments, and the URL for making access to the application, with the token to be notified to the client, with respect to each of the combinations of the application ID and the version (S111), and notifies, when the application utilization instruction, including the token, the application ID, and the version is transmitted at S122 from the client, the token and the URL associated with the application ID and the version, to the client (S129).

Hereunder, the system 10 according to a third embodiment of the disclosure will be described. Regarding the third embodiment, the description of the elements or operations similar to those of the first embodiment will not be repeated. In other words, the configuration and operation of the token control device 20, the cache device 30, the application provision device 40, and the client 50 of the system 10 according to the third embodiment are similar to those of the first embodiment, unless otherwise specifically noted.

In the third embodiment, when the application utilization instruction, instructing to utilize the application, and including the token and the application ID, is transmitted from the client, the token controller 25a reproduces specific information, associated with the token included in the application utilization instruction, and with a specific application ID other than the application ID included in the application utilization instruction, as the information associated with the token and the application ID included in the application utilization instruction, and notifies the URL associated with the token and the application ID included in the application utilization instruction, to the client 50.

The description given hereunder refers to the case where, when the application utilization instruction is transmitted from the client, it is decided through the URL identification process by the cache device 30 (S124) that the URL is available, and the URL is notified (S128), the token controller 25a reproduces the specific information, associated with the token included in the application utilization instruction, and with a specific application ID other than the application ID included in the application utilization instruction, as the information associated with the token and the application ID included in the application utilization instruction, and notifies the URL associated with the token and the application ID included in the application utilization instruction, to the client 50.

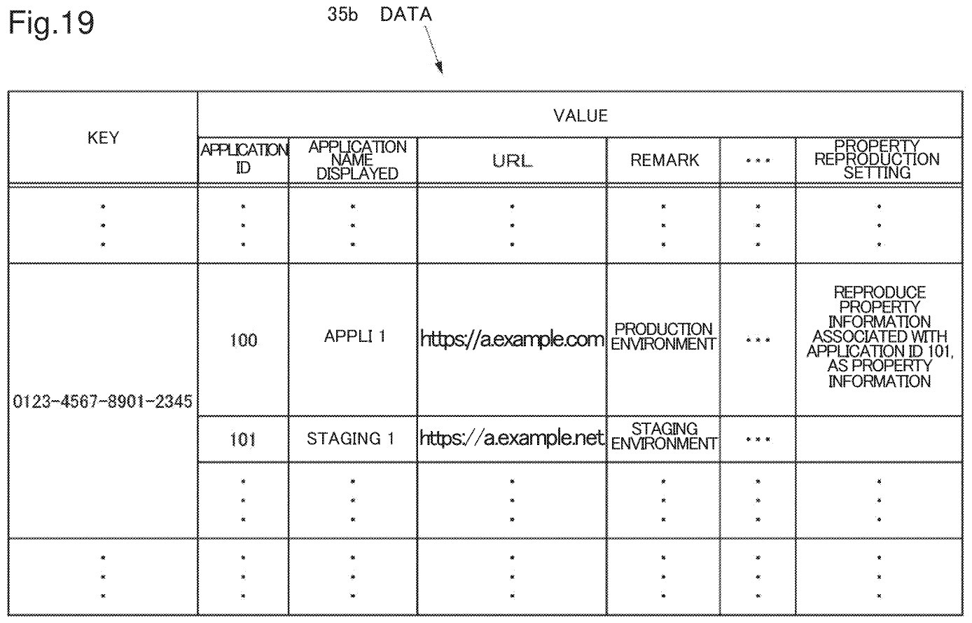

The data 35b used in the third embodiment will be described hereunder. FIG. 19 is a table showing an example of the data 35b.

As shown in FIG. 19, the data 35b includes the token as the key. The data 35b includes the information about the user to whom the token is applicable, and setting related to reproduction of property information, included in the information about the user (hereinafter, “property reproduction setting”), as the value. The information about the user includes, for example, the application ID serving as the identification information of the application provided by the application provision device 40, the application name displayed in the application provision device 40, the URL for making access to the application, and the remark about the application, with respect to each of the application IDs. The information included in the information about the user, other than the application ID, is the property information. The property reproduction setting may be set, for example, so as to reproduce the property information associated with the application ID “101” as the property information associated with the application ID “100”.

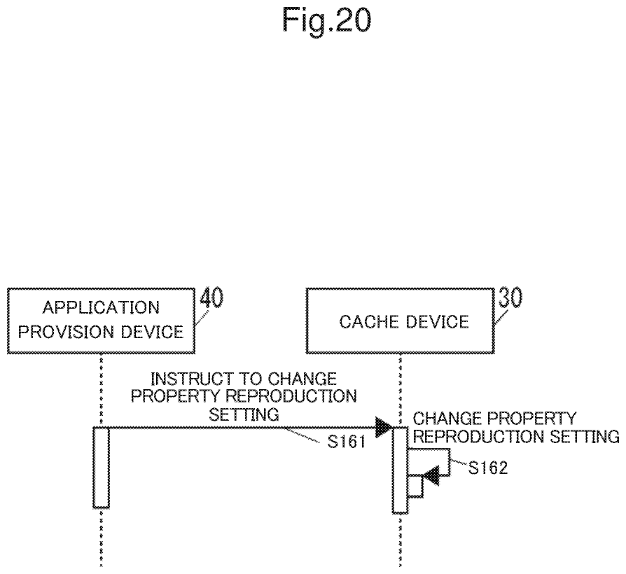

Hereunder, an operation of the system 10 according to the third embodiment, performed when the property reproduction setting is changed, will be described. FIG. 20 is a sequence chart showing an operation of the system 10, performed when the property reproduction setting is changed;

The manager can log in to the application provision device 40 via a non-illustrated computer, and instruct the application provision device 40 to change the property reproduction setting. When the change of the property reproduction setting is instructed, the platform 45a of the application provision device 40 instructs the cache device 30 to change the property reproduction setting, according to the instruction from the manager, as shown in FIG. 20 (S161).

Upon receipt of the instruction of S161, the token retainer 35a of the cache device 30 changes the property reproduction setting in the RAM 35C, according to the instruction of S161 (S162).

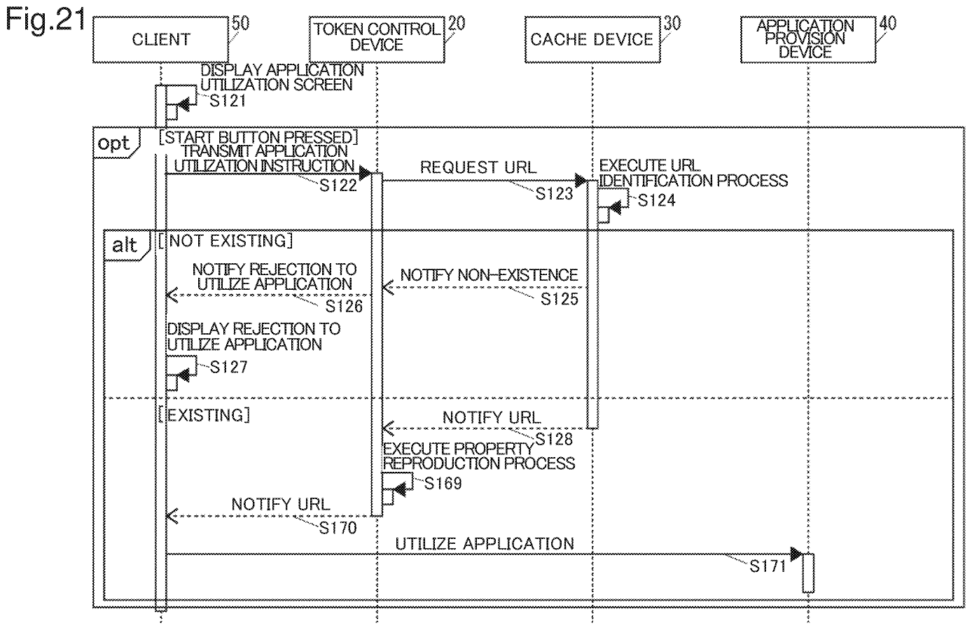

Hereunder, an operation of the system 10 according to the third embodiment, performed when the application provided by the application provision device 40 is utilized by the client 50, will be described. FIG. 21 is a sequence chart showing the operation of the system 10 according to the third embodiment, performed when the application provided by the application provision device 40 is utilized by the client 50.

In the operation of the system 10 according to the third embodiment, performed when the application provided by the application provision device 40 is utilized by the client 50, when the token retainer 35a of the cache device 30 decides, through the URL identification process of S124, that the URL requested at S123 is included in the data on the RAM 35C, and notifies the URL identified through the URL identification process of S124 to the token control device 20 (S128), the token controller 25a of the token control device 20 executes, upon receipt of the notice of S128, a process to reproduce the property information (hereinafter, “property reproduction process”) (S169).

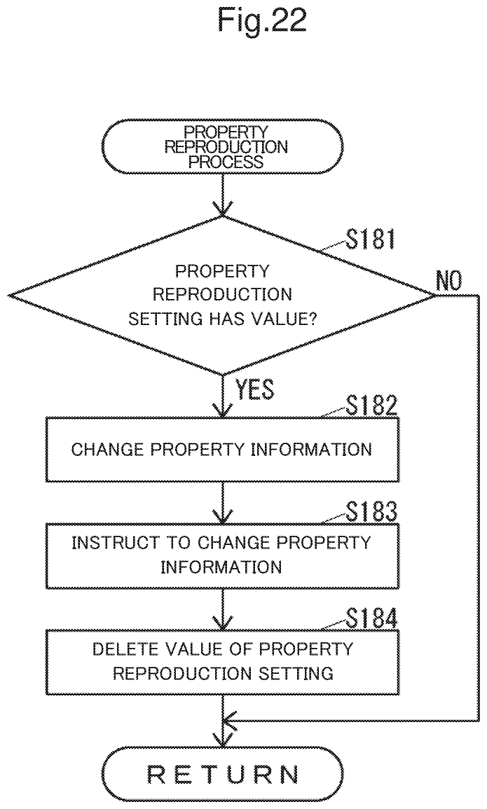

FIG. 22 is a flowchart specifying the property reproduction process shown in FIG. 21.

As shown in FIG. 22, the token controller 25a decides whether the property reproduction setting associated with the application ID included in the application utilization instruction has a value, in the value the key of which is the token included in the application utilization instruction, among the data on the RAM 35C of the cache device 30 (S181).

Upon deciding at S181 that the property reproduction setting associated with the application ID included in the application utilization instruction has a value, in the value the key of which is the token included in the application utilization instruction, among the data on the RAM 35C of the cache device 30, the token controller 25a changes the property information in the value the key of which is the token included in the application utilization instruction, among the data on the RAM 35C of the cache device 30, according to the property reproduction setting associated with the application ID included in the application utilization instruction, in the value the key of which is the token included in the application utilization instruction, among the data on the RAM 35C of the cache device 30 (S182).

The property reproduction setting includes reproducing the property information (application name displayed, URL, and remark inclusive), associated with the specific application ID different from the application ID included in the application utilization instruction, as the property information associated with the application ID included in the application utilization instruction. The token controller 25a changes the property information on the side of the specific application ID, as the property information on the side of the application ID included in the application utilization instruction, on the basis of the property reproduction setting stored in the value the key of which is the mentioned token.

After finishing the operation of S182, the token controller 25a instructs the platform 45a of the application provision device 40 to make the same change as that of S182 (S183). Accordingly, the platform 45a makes the same change as that of S182, with respect to the application management information 44e.

After finishing the operation of S183, the token controller 25a of the token control device 20 deletes the value of the property reproduction setting associated with the application ID included in the application utilization instruction, in the value the key of which is the token included in the application utilization instruction, among the data on the RAM 35C of the cache device 30 (S184).

Upon deciding at S181 that the property reproduction setting associated with the application ID included in the application utilization instruction does not have a value, in the value the key of which is the token included in the application utilization instruction, among the data on the RAM 35C of the cache device 30, or finishing the operation of S184, the token controller 25a finishes the property reproduction process specified in FIG. 22.

As shown in FIG. 21, after finishing the property reproduction process of S169, the token controller 25a of the token control device 20 notifies the URL notified at S128, to the client 50 (S170).

Upon receipt of the notice of S170, the application utilizer 55a of the client 50 utilizes the application corresponding to the application ID included in the application utilization instruction, by making access to the URL notified at S170 (S171).

According to the third embodiment, as described above, when the application utilization instruction is transmitted from the client, the token controller 25a reproduces the specific information, associated with the combination of the token included in the application utilization instruction, and the specific application ID other than the application ID included in the application utilization instruction, as the information associated with the token and the application ID included in the application utilization instruction (S182). Therefore, the transition between the environments can be facilitated.

As described above, the token controller 25a of the token control device 20 decides whether the property reproduction setting associated with the application ID included in the application utilization instruction has a value, in the value the key of which is the token included in the application utilization instruction, among the data on the RAM 35C of the cache device 30 (S181). Instead, the token controller 25a may decide at S181 whether the property reproduction setting associated with the application ID included in the application utilization instruction has an effective value, in the value the key of which is the token included in the application utilization instruction, among the data on the RAM 35C of the cache device 30. Then upon deciding at S181 that the property reproduction setting associated with the application ID included in the application utilization instruction has an effective value, in the value the key of which is the token included in the application utilization instruction, among the data on the RAM 35C of the cache device 30, the token controller 25a may invalidate at S184, after executing the operation of S182 and S183, the value of the property reproduction setting associated with the application ID included in the application utilization instruction, in the value the key of which is the token included in the application utilization instruction, among the data on the RAM 35C of the cache device 30.

In the case of an application management technique, not configured like the foregoing embodiments, the token for making access to the environment differs depending on the environments, and therefore the token has to be managed with respect to each of the environments. The arrangements according to the foregoing embodiments, in contrast, enable the same token to be utilized, without depending on the environment of the application.

While the present disclosure has been described in detail with reference to the embodiments thereof, it would be apparent to those skilled in the art that various changes and modifications may be made therein within the scope defined by the appended claims.

What is claimed is;

1. A token control device comprising:
a storage device in which a token control program is stored; and
a control device that includes a processor, and acts, when the processor executes the token control program, as a token controller that:
notifies, when a client requests permission for a user to log in to an application provision device that provides applications, each having an application ID, serving as identification information and different in each of environments, and the permission to log in is granted, a token to the client, and associates the application ID of the application and a URL for making access to the application, with the token, with respect to each of the application IDs; and
notifies, when an application utilization instruction, instructing to utilize the application, and including the token and the application ID, is transmitted from the client, the token included in the application utilization instruction and the URL associated with the application ID, to the client.

2. The token control device according to claim 1,
wherein, when the client requests permission for the user to log in to the application provision device, and the permission to log in is granted, the token controller notifies the token to the client, and associates a combination of the application ID and a version of the application and the URL for making access to the application, with the token, with respect to each of the combinations of the application ID and the version, and
when the application utilization instruction, instructing to utilize the application, and including the token, the application ID, and the version, is transmitted from the client, the token controller notifies the URL associated with the token, the application ID, and the version included in the application utilization instruction, to the client.

3. The token control device according to claim 1,
wherein, when the application utilization instruction, instructing to utilize the application, and including the token and the application ID, is transmitted from the client, the token controller reproduces specific information, associated with a combination of the token included in the application utilization instruction, and a specific application ID other than the application ID included in the application utilization instruction, as information associated with the token and the application ID included in the application utilization instruction, and notifies the URL associated with the token and the application ID included in the application utilization instruction, to the client.

4. A computer-readable, non-transitory recording medium having a token control program recorded thereon,
the token control program being configured to cause a computer to act as a token controller that:
notifies, when a client requests the computer to permit a user to log in to an application provision device that provides applications, each having an application ID, serving as identification information and different in each of environments, and the permission to log in is granted, a token to the client, and associates the application ID of the application and a URL for making access to the application, with the token, with respect to each of the application IDs; and
notifies, when an application utilization instruction, instructing to utilize the application, and including the token and the application ID, is transmitted from the client to the computer, the token included in the application utilization instruction and the URL associated with the application ID, to the client.

5. The computer-readable, non-transitory recording medium having the token control program recorded thereon, according to claim 4,
wherein the token control program causes a computer to cause the token controller to:
notify, when the client requests permission for the user to log in to the application provision device, and the permission to log in is granted, the token to the client, and associate a combination of the application ID and a version of the application and the URL for making access to the application, with the token, with respect to each of the combinations of the application ID and the version; and
notify, when the application utilization instruction, instructing to utilize the application, and including the token, the application ID, and the version, is transmitted from the client, the URL associated with the token, the application ID, and the version included in the application utilization instruction, to the client.

6. The computer-readable, non-transitory recording medium having the token control program recorded thereon, according to claim 4,
wherein the token control program causes a computer to cause the token controller to:
reproduce, when the application utilization instruction, instructing to utilize the application, and including the token and the application ID, is transmitted from the client, specific information associated with a combination of the token included in the application utilization instruction, and a specific application ID other than the application ID included in the application utilization instruction, as information associated with the token and the application ID included in the application utilization instruction, and notify the URL associated with the token and the application ID included in the application utilization instruction, to the client.

7. A system comprising:
a token control device that executes control related to a token;
a cache device that retains the token; and
an application provision device that provides applications, each having an application ID, serving as identification information and different in each of environments,
wherein, when a client requests permission for a user to log in to the application provision device, and the permission to log in is granted, the token control device notifies the token to the client, and stores the application ID of the application and a URL for making access to the application, in the cache device in association with the token, with respect to each of the application IDs, and
when an application utilization instruction, instructing to utilize the application, and including the token and the application ID, is transmitted from the client, the token control device notifies the token included in the application utilization instruction and the URL stored in the cache device in association with the application ID, to the client.

8. The system according to claim 7,
wherein, when the client requests permission for the user to log in to the application provision device, and the permission to log in is granted, the token control device notifies the token to the client, and associates the application ID and a version of the application and the URL for making access to the application, with the token, with respect to each of combinations of the application ID and the version, and
when the application utilization instruction, instructing to utilize the application, and including the token, the application ID, and the version, is transmitted from the client, the token control device notifies the URL associated with the token, the application ID, and the version included in the application utilization instruction, to the client.

9. The system according to claim 7,
wherein, when the application utilization instruction, instructing to utilize the application, and including the token and the application ID, is transmitted from the client, the token control device reproduces specific information, associated with a combination of the token included in the application utilization instruction, and a specific application ID other than the application ID included in the application utilization instruction, as information associated with the token and the application ID included in the application utilization instruction, and notifies the URL associated with the token and the application ID included in the application utilization instruction, to the client.
